(19) United States
(12) Patent Application Publication
(10) Pub. No.: US 2005/0257380 A1
(43) Pub. Date: Nov. 24, 2005

(54) Hand-held device

(75) Inventors: Reinhard Karl, Weiler (DE); Harald Kuisle, Leutkirch (DE)

Correspondence Address: ROTHWELL, FIGG, ERNST & MANBECK, P.C., 1425 K STREET, N.W., SUITE 800, WASHINGTON, DC, 20005, US

(73) Assignee: Armacell Enterprise GmbH, Muenster (DE)

(21) Appl. No.: 10/954,661

(22) Filed: Oct. 1, 2004

(30) Foreign Application Priority Data
Oct. 7, 2003 (DE) 103 46 582.0

(51) Int. Cl. B67B 7/00; B26B 3/00

(52) U.S. Cl. 30/319

(57) ABSTRACT

The hand-held device (21) is used for applying protective profiles (22) made of flexible material and comprising a spine and two lips to edges (24) of objects (23) for the purpose of protecting them. It includes two side panels (26) that are mounted parallel to one another spaced at a fixed distance from one another, a handle (25), and above and between the side panels on the protective profile outlet side a device (32) for guiding and pressing the protective profile (22) onto the edge (24), and below a device (33) in the form of a wedge element (34) for opening up the protective profile in the form of a wedge element (34), and underneath the wedge element (34) a device (37) with a guide surface for guiding the hand-held device (21) along the edge (24). The wedge element (34) has a wide section (35), which is fastened to the side panels (26), and a narrow section (36), which is positioned a certain distance from the device (32) for the purpose of guiding and pressing the protective profile (22), and which corresponds at a minimum to the thickness of the spine of the protective profile (22). The wedge element (34) ends in front of the tangent that extends between the inner surface of the spine of the protective profile (22) and the guide surface of the device (37) for guiding the hand-held device (1) along the edge (24).

### BACKGROUND OF THE INVENTION

1. Field of the Invention

The invention relates to a hand-held device for use in applying a protective profile made of flexible material to the edges of an object for the purpose of protecting it.

2. Description of the Background Art

With one hand-held device of this type, known from GB 15 88 213 A, the guide mechanism for the protective profile that is located on the protective profile intake side is comprised of a guide channel positioned between the side panels, which is designed to accommodate the U-shaped cross section of the protective profile in such a way that the protective profile can be pushed through it without becoming twisted. To this end a divider panel extends from the one channel wall into the protective profile through its open side. On the cylinder that bears the flanged wheels, pins are provided, which mesh with the rear of the protective profile to create its forward movement with the turning of the cylinder. Below this cylinder that bears the pins, guide plates are positioned on the side panels, and are in contact with the side walls of an object in the form of a disk that is to be protected, to the edge or rim of which the protective profile is to be applied. When the hand-held device is positioned on the edge of the disk in such a way that the protective profile can be applied to it, the guide axis of the guide channel forms an acute angle with the edge of the disk. In the region of this acute angle, on the side panels, a guide cylinder that contains a recessed area is provided, which corresponds to the thickness of the disk, so that the edges of the guide cylinder overlap the edge of the disk. In the surface of the guide channel that faces the spine of the protective profile a recessed area is provided, in which a retaining pawl becomes engaged; with the actuation of a tang, the withdrawal of the protective profile from the guide channel is enabled. Between this actuating tang and the disk a handle is provided on the hand-held device. Connected to the actuating tang is a bar linkage on which a cutting blade rests, which can engage in a slit in the guide channel in order to cut off the protective profile when the actuating tang is actuated. The slit that enables the cutting off of the profile is located in the side of the guide channel in which the recessed area for the retaining pawl is located. It is not possible to apply protective profiles of various dimensions to the edges of objects of varying thicknesses for the purpose of protecting them using the known hand-held device.

From DE 41 04 342 C1 a hand-held device for use in mounting a sealing profile in a holding groove with mitered corners is known, which comprises a completely closed guide channel for the sealing profile. For stamping out a section of the sealing profile or for cutting off the sealing profile, a stamping tool is provided on the hand-held device, which can be pushed into said device perpendicular to the guide channel. The stamping tool can be rotated around an axis that extends parallel to the direction of movement of the stamping blade and can be halted in at least two rotational positions. It is equipped with markings or stops to indicate the desired position for the mitered or blunt cut. A pressure roller is provided on the exit side of the hand-held device, which continuously rolls up the sealing profile in the holding groove. The hand-held device further comprises a drag anchor with resistance hooks, which are arranged in such a way that the sealing profile can be moved in only one direction. In order to guide the hand-held device along one edge of the object to which the seal is to be applied, the hand-held device is equipped with a sliding edge. Because the hand-held device is equipped with a guide channel, the hand-held device can be used only in conjunction with sealing profiles of equal dimensions.

Another known-in-the-art component is a hand-held device (made by NMC, Raeren, Belgium) for use in the application of primarily U-shaped protective profiles made of flexible material and comprising a spine and two ribs to the edges of objects for the purpose of protecting them. This hand-held device has two side panels mounted parallel to one another and separated by a fixed distance, wherein each of said panels has the shape of a trapezoid with one long parallel trapezoid side, with one short parallel trapezoid side, with one side of the trapezoid on the protective profile intake side, and with one side of the trapezoid on the protective profile outlet side. A handle is connected to the side panels. Between the side panels, in the area of the long parallel trapezoid side and the trapezoid side on the protective profile outlet side, a device for guiding and pressing the protective profile onto the edge is arranged. The hand-held device further comprises a device for opening up the protective profile, located in the area of the short parallel trapezoid side from the protective profile outlet side trapezoid side of the side panels, which device is comprised of a narrow, rotatable circular disk that is arranged very close to the device for guiding and pressing the protective profile onto the edge, which is formed by a cylinder with lateral flanged wheels; this arrangement produces a large bending angle in the protective profile when it is applied to the edge of the object to be protected. This large bending angle causes the profile to tend to close up as a result of its restoring force, thereby making the application to the edge very difficult, and completely preventing it after a certain length. The guidance of the hand-held device relative to the edge of the object to be protected is accomplished with the help of the profile and via the cylinder with the flanged wheels. This type of guidance mechanism is highly unstable.

With the known hand-held device, the tang is positioned on the side panels on their short parallel trapezoid sides, which makes working with the hand-held device more difficult for the operator. Furthermore, for certain profile shapes precise guidance in the hand-held device is not ensured, so that the protective profile can become twisted, causing guidance via the circular disk to cease. The device is not equipped with cutting or notching devices or retraction prevention devices.

### SUMMARY OF THE INVENTION

The object of the invention is thus to further improve upon the hand-held device of the type initially specified for a simple actuation, such that a continuous application of different types of protective profiles to edges or rims of various widths on the objects to be protected is ensured, without the risk of damaging the edge.

This object is attained based upon the hand-held device of the type described at the beginning with the features disclosed herein.

With the hand-held device specified in the invention, in adjusting to the specific thickness of objects to be protected, protective profiles of various dimensions made of flexible material, which are equipped with an insertion slit that extends along their longitudinal axis and are designed to hold the edge of the object to be protected, are continuously and reliably guided, requiring a low level of energy on the part of the operator, onto the edge or the rim of the object to be protected, wherein the hand-held device is also reliably guided along the edges or the rims of the objects to be protected which are of varying thicknesses.

One embodiment of the hand-held device enables a simple adjustment to various protective profile designs.

Based upon the cutting device disclosed in another embodiment, to which the hand-held device is directly connected, cutting surfaces are received with the same orientation, so that the cutting surfaces at the ends of the protective profile match one another congruently.

With the most simple embodiment of the retraction prevention device, a degree of resistance keeps the protective profile from being pulled out of the hand-held device, which prevents the section of the protective profile on the inlet side from becoming detached after the section of the protective profile on the outlet side is cut off.

The hand-held device pursuant to another embodiment ensures that the cutting off of the protective profile is gentle to the blade, and is free from default and deformation.

With one embodiment, the two retraction prevention devices, which are positioned opposite one another, ensure the centering of the protective profile and at the same time prevent the twisting of the protective profile within the hand-held device.

Another embodiment of the hand-held device provides for an intake-side opening up of the protective profile, and contributes to preventing the twisting of the profile inside the hand-held device. With the vertical adjustability of the guide cylinders a simple adjustment to accommodate various spine thicknesses of protective profiles is possible.

In addition, one embodiment allows an adjustment to different profile sizes, wherein the side panels can be relatively widely spaced from one another, thereby enabling even very wide profiles to pass through, without endangering their stable guidance.

Frequently in the guidance of protective profiles around the edges of an object to be protected, the profiles must also be guided around corners and sharp bent areas. In order to ensure that this can be accomplished successfully, in embodiment, the release of segments from the lips of the protective profile that border the intake slit is possible via simple means. In this manner, the segments in the protective profiles, which are supplied as continuous material, can always be released at the desired points, so that a corresponding preassembly with the disadvantages associated with it is eliminated. The segments can easily be disengaged via direct actuation on the hand-held device. The disengagement device can be designed as an integrated component of the hand-held device or as an attachment thereto, whereby in the latter case an additional device for opening up the protective profile must also be included on the protective profile intake side.

With the hand-held device in another embodiment the cutting blades can be easily operated.

The shape of the hand-held device may be highly ergonomic, so that the hand-held device can be conveniently used by the operator in the widest range of settings.

The hand-held device in one embodiment can also be used to apply insulated sleeving to a tube that requires insulation, wherein in this case the protective profile is the insulated sleeving and the edge is formed by the tube to be insulated. If the insulated sleeving is not already equipped with slits, it is slit longitudinally on the intake side and then is opened up. Shortly before it is applied to the tube, the slit surfaces are heated by the welding device and then are pressed against one another in the cylinder with the flanged wheels, becoming attached to one another.

### BRIEF DESCRIPTION OF THE DRAWINGS

With reference to the drawings, the invention will be described in greater detail by way of example. The drawings show

FIG. 1 a lateral view of a first embodiment of a hand-held device according to the invention,

FIG. 2 in a view similar to that in FIG. 1, the hand-held device from FIG. 1 in a modified embodiment,

FIG. 3 the hand-held device from FIG. 2 in an end view,

FIG. 4 in a view similar to that in FIG. 3, the hand-held device from which the object has been released,

FIG. 5 in a view similar to that in FIG. 1 a second embodiment of a hand-held device with release elements, and

FIG. 6 in a view similar to that in FIG. 5, the hand-held device being used to apply insulated sleeving to a tube.

### DETAILED DESCRIPTION OF THE INVENTION

The hand-held device 21 shown in the drawings has two side panels 26, which are attached to one another via spacer bolts and other devices at various points, at a predetermined distance from one another, in such a way that they extend parallel to one another.

Each side panel 26 is essentially trapezoidal in shape with one upper long parallel trapezoid side 29, one lower short parallel trapezoid side 30, one trapezoid side on the protective profile intake side 28 and one trapezoid side on the protective profile outlet side 27, which extends beyond the upper long parallel trapezoid side 29 in the form of a projection 49.

Between the free end of the projection 49 and the protective profile intake side end of the long parallel trapezoid side there extends an ergonomically designed handle 25.

An object 23 with an edge 24 that is to be protected is positioned as shown in the drawings. A protective profile 22 is to be applied to the edge 24, which profile is equipped with an insertion slit for the edge 24 that extends along its longitudinal axis. In the exemplary embodiment shown, the protective profile 22 is essentially U-shaped in its cross-section, with a spine and two lateral lips that extend from the spine. The protective profile 22 is forced through the space between the side panels 26 from the intake side to the outlet side.

When the protective profile 22 is inserted into the hand-held device 21, it extends along a retraction prevention device 46, which is formed by a spring leaf that is mounted on the outer surface of each of the side panels 26 on the protective profile intake side, and extends through an opening in each of the side panels 26 up to an engagement contact on the outer surfaces of the lips of the protective profile 22. In this manner the protective profile 22 is centered between the two spring leaves and is prevented from falling out on the protective profile intake side, especially once it has been cut off, while its advancement is not adversely affected.

In the area of the retraction prevention device 46 another device for opening and guiding the protective profile 22 is provided between the side panels 26. This second device is comprised of a circular disk 47 that engages in the space between the lips of the protective profile 22 and whose position can be adjusted and fixed by means of an adjustment lever that is coupled to the side panels 26. The device further comprises a cylinder 48 that is meshed with the outer surface of the spine of the protective profile 22, the position of which in FIG. 1 can be adjusted vertically to accommodate various profile sizes. The circular disk 47 and the guide cylinder 48 ensure that the protective profile 22 cannot become twisted as it passes through the hand-held device 21.

In the direction of advancement of the protective profile 22 the devices 46 and/or 47, 48 in each side panel are followed by a slit 42 that extends all the way through the panel. The slits 42 of the facing side panels 26 are aligned axially to one another and cover the entire span of the profile, so that by passing a cutting blade through the slit 42, the protective profile 22 can be cut off. In the exemplary embodiment shown, angled cuts can be achieved. However, with the proper design of the slits 42, any desired shape of cutting surface can be created in the protective profile 22.

In the lower section of FIG. 1, in other words on the end of the lower short parallel trapezoid side on the protective profile outlet side, and the trapezoid side 27 on the protective profile outlet side, a device 37 for guiding the hand-held device along the edge 24 is provided. In the embodiment shown here this is a cylinder 41 in the form of two truncated cones that lie adjacent to one another along their smaller-diameter sides. In this manner the cylinder 41 can reliably guide the edges 24 of the object 23 of varying thicknesses along guiding lines.

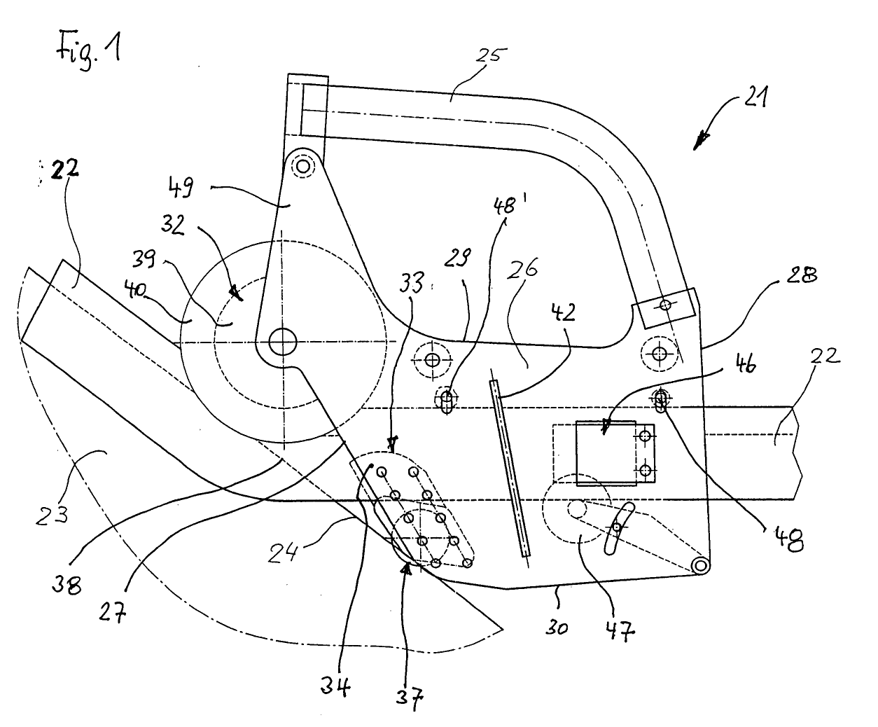

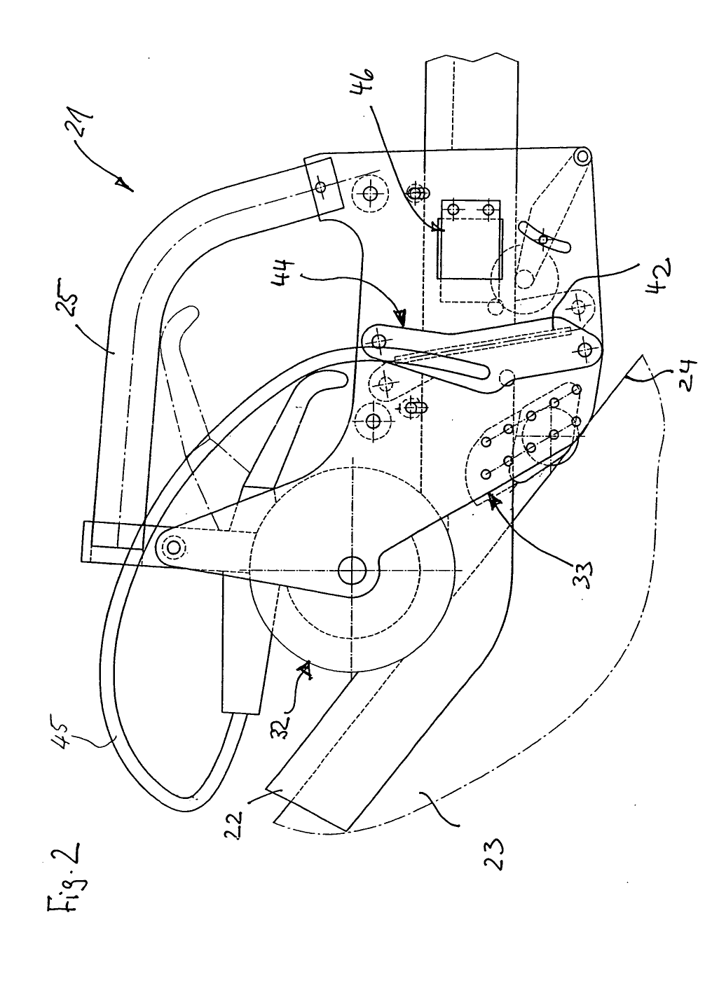

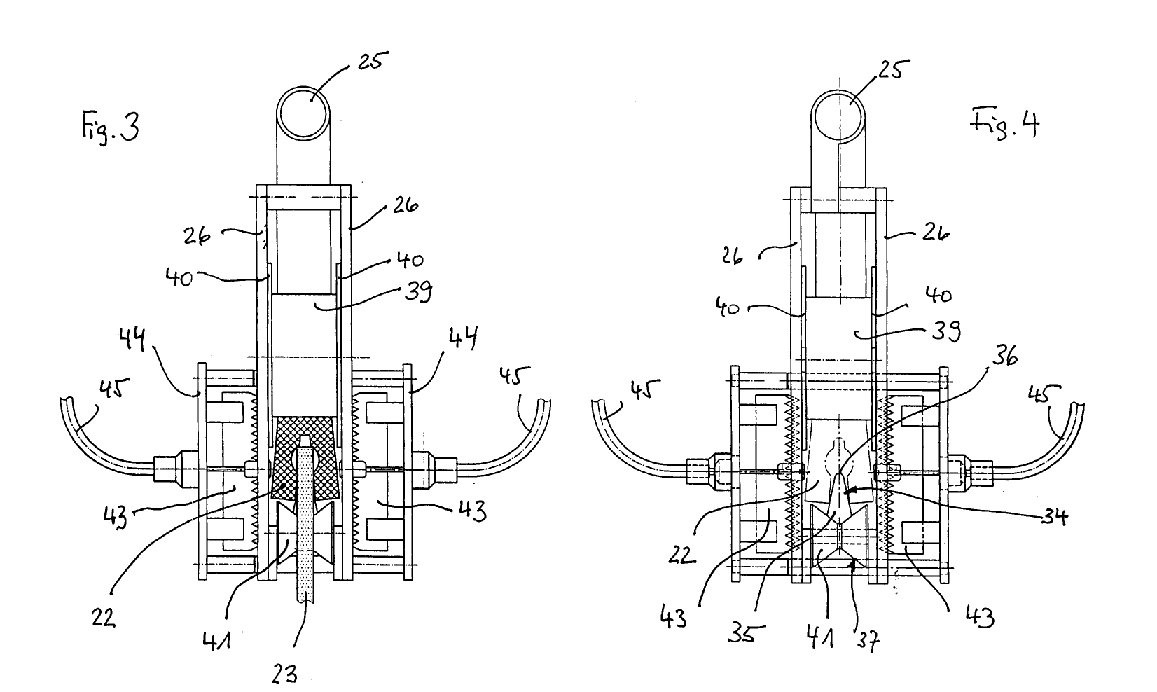

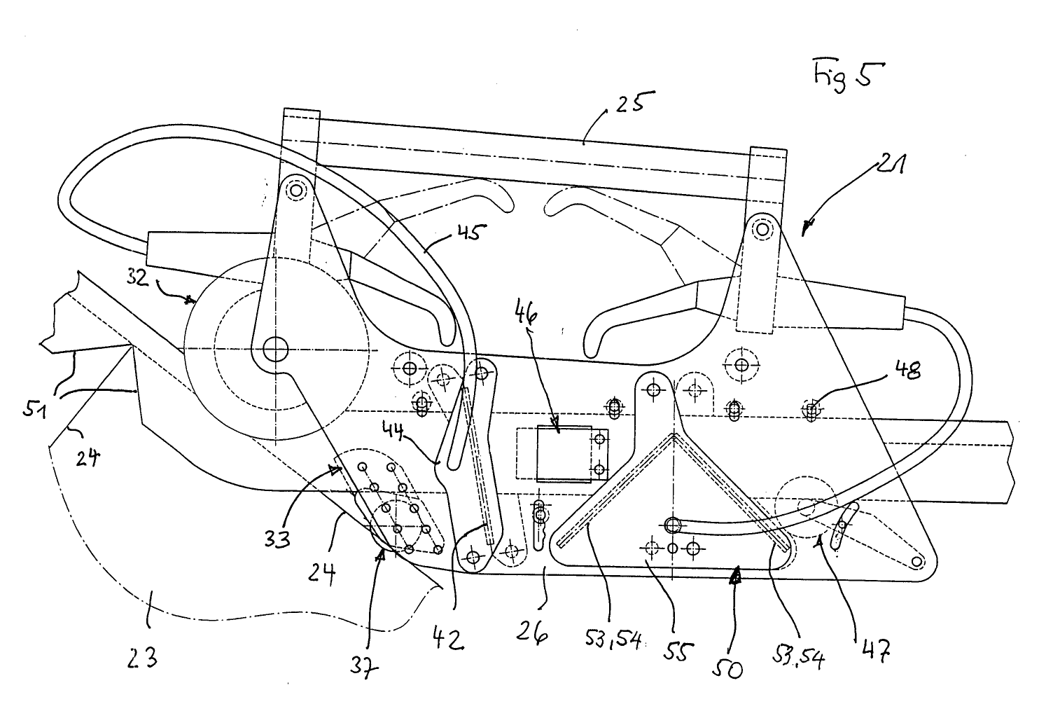

Positioned next in sequence after the cylinder 41, in the direction of advancement of the protective profile 22, is a device 33 for opening up the protective profile, which comprises a wedge element 34 that, as can be seen in FIG. 3 and FIG. 4, is fastened with its wide section 35, which faces the cylinder 41, between the side panels 26, and whose narrow section 36 extends between the lips of the protective profile 22.

The wedge element 34 is followed by a device 32 for guiding and pressing the protective profile 22 onto the edge 24 toward the profile outlet side, which is positioned between the side panels 26 in the area of the protective profile outlet side end of the upper long parallel trapezoid side 29. The device 32 for guiding and pressing the protective profile 23 onto the edge 24 comprises a cylinder 39, wherein each end surface of said cylinder is equipped with a flanged wheel 40. The radial distance between the outer circumference of the cylinder 39 and the outer circumference of each flanged wheel 40 is approximately equal to the thickness of the spine of the inserted protective profile 22. The flanged wheels 40 can be displaced in the direction of the axis of the cylinder 39, and thus can be adjusted to the width of the profile, which changes as it is widened.

The insertion depth of the wedge element 34 between the lips of the protective profile 22 is adjustable, which is illustrated by a multitude of borings in FIGS. 1 and 2, and in 5 and 6.

The protective profile outlet side end of the wedge element 34 cannot come into contact with the edge 24 of the object 23 to be protected, as this could cause damage. For this reason, the extension of the end of the wedge element 23 on the protective profile outlet side is limited such that it ends before the tangent that extends between the inner surface of the spine of the protective profile 22 and the current guiding line of the cylinder 41 for guiding the hand-held device 1 along the edge 24, i.e. such that there is a safety margin to the edge 24 that corresponds essentially to this tangent.

The embodiment of the hand-held device 21 shown in FIG. 1 corresponds essentially to that of FIG. 2, with the addition that an actuation device 44 is provided on the outer side of each side panel 26, with each of these devices, as can be seen in FIGS. 3 and 4, being equipped with a blade 43 that can be passed through the accompanying slit 42 in the corresponding side panel 26 via the actuating device 44 for the purpose of cutting through the protective profile 22. As is shown in FIGS. 3 and 4, the cutting edges of the blade 43 are serrated, which substantially decreases the amount of cutting force required. The actuating device 44 is activated via a control cable, as is indicated schematically by the FIG. 45, and can be moved between two positions, namely an idle position and a cutting position, which are shown in FIG. 2 by solid and dash-dotted lines, respectively.

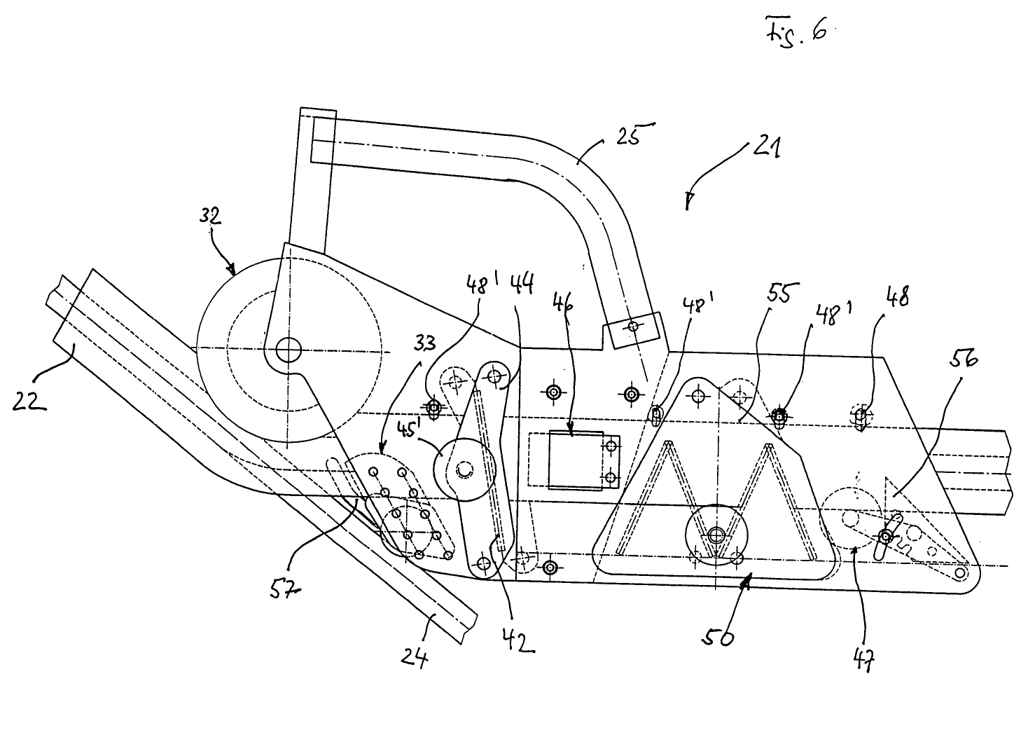

In the embodiment shown in FIG. 5, the hand-held device from FIG. 1 through 4 is supplemented with a device 50, on the protective profile intake side, designed to release segments 51 from the lips of the protective profile 22.

The device 50 is comprised of one actuating device 55 for each side panel 26, with each actuating device bearing a blade 54 that is assigned a corresponding slit in the side panel 26. In the embodiment shown here, two blades 54 are provided, which come together in a right-angled peak, whereby the segment 51 of the protective profile 22, shown on the left in FIG. 5, can be cut out. As can be seen in FIG. 5, each actuating device 55 is equipped with a control cable with an actuating handle. The other device 47, 48 for guiding and opening up the protective profile 22 is then provided on the protective profile intake side of the device 50.

In the embodiment shown in FIG. 6, an insulated sleeving 22 is being applied to a tube 24 using the hand-held device, wherein the insulated sleeving is slit open on the intake side by means of a splitting blade 56; after being opened up, it is heated via a welding or heating device 57 along the cut surfaces, and after being placed around the tube 24, which is accomplished in exactly the same way that the protective profile 22 is placed on the edge 24 of the object 23, the sleeving is rejoined along the heated cut surfaces with the help of the device 32 for pressing and guiding, to form a closed tube. The insulated sleeving can be cut off by means of blades, for which at least one slit 42 and one actuating device 44 are provided, wherein the activation can be accomplished via pneumatic or hydraulic cylinders 45′.

The device 50 for releasing segments comprises a blade assembly that will enable the release of segments that the insulated sleeving can stretch around tube bends.

For the reliable guidance of the protective profile 22 via the hand-held device 21, additional height-adjustable guide cylinders 48′ are provided, spaced from one another in the direction of advancement of the protective profile, for engagement with the spine of the protective profile 22.

1. Hand-held device (21) for use in applying a protective profile (22) made of flexible material to the edges (24) of an object (23) for the purpose of protecting it, to which end the protective profile (22) is provided with an insertion slit that extends along the longitudinal axis of the profile, and wherein the hand-held device (21) comprises
Two side panels (26) mounted at a fixed distance, parallel to one another, between which the protective profile (22) is transported from a protective profile intake side (28) to a protective profile outlet side (27),
A handle (25) that is connected to the side panels (26),
A guide device (47, 48) for the protective profile (22), located on the protective profile intake side,
A cylinder (39) that is rotatably mounted between the side panels (26) and comprises lateral flanged wheels (40) for guiding and pressing the protective profile (22) onto and against the edge (24) of the object (23) to be protected,
A device (37) with a cylinder (41) that is used to guide the hand-held device (21) along the edge (24) of the object (23) to be protected,
A retraction prevention device (46) that engages the protective profile (22) on the protective profile intake side, and
Devices (42, 43; 50) for at least one of notching or cutting through the protective profile (22),
Characterized in that
A wedge element (34) designed to open up the insertion slit in the protective profile (22) is positioned between the cylinder (39) that bears the flanged wheels (40) and the cylinder (41) that is designed to guide the hand-held device (21) along the edge (24), wherein the broad section of said wedge element is fastened between the side panels (26) while its narrow section (36) extends into the insertion slit in the protective profile (22),
The lateral flanged wheels (40) can be displaced in the direction of the axis of their cylinder (39), and
The cylinder (41) of the device (34) for guiding the hand-held device (21) along the edge (24) of the object (23) to be protected is in the shape of two truncated cones, whose smaller diameter surfaces are adjacent to one another.

2. Hand-held device pursuant to claim 1, characterized in that the insertion depth of the wedge element (34) into the insertion slit in the protective profile (22) can be adjusted within a plane that is parallel to the planes of the two side panels (26).

3. Hand-held device pursuant to claim 1, characterized in that the devices (42, 43; 50) for at least one of notching or cutting through the protective profile (22) are equipped with blade slits (42, 53) located in the side panels (26) between the protective profile outlet side (27) and the protective profile intake side (28), wherein said slits are aligned axially with one another and extend at least farther than the size of the protective profile, wherein at least one side panel (26) is equipped with a blade (43, 54) with an actuating device (44, 55) that shifts the blade (43, 54) essentially perpendicular to the side panel (26).

4. Hand-held device pursuant to claim 1, characterized in that the retraction prevention device (46) is a leaf spring, which projects from at least one side panel (26) into the space between the side panels (26) in order to engage with the protective profile (22), in such a way that the protective profile (22) can be guided from the protective profile intake side (28) to the protective profile outlet side (27) and is protected against falling out on the protective profile intake side.

5. Hand-held device pursuant to claim 1, characterized in that each side panel (26) is equipped with a blade (43), and in that the two blades (43) overlap during cutting.

6. Hand-held device pursuant to claim 1, characterized in that each side panel (26) is equipped with a leaf spring as a retraction prevention device (46) for the purpose of centering the protective profile (22).

7. Hand-held device pursuant to claim 1, characterized in that the guide device (47, 48) for the protective profile (22) comprises a circular disk (47) provided for engagement in the insertion slit of the protective profile (22), and at least one guide cylinder (48), which is arranged such that it can be adjusted perpendicular to the direction of advancement of the protective profile (22) in order to engage with the outer surface of the protective profile.

8. Hand-held device pursuant to claim 7, characterized in that the circular disk (47) can be adjusted within a plane that extends parallel to the planes of the side panels (26).

9. Hand-held device pursuant to claim 1, characterized in that the devices for notching the protective profile are equipped with devices (50) for releasing segments (51) from the sides of the protective profile (22), which are arranged between the blade slits (43) of the cutting device (42, 43, 44) and the guide device (47, 48) for the protective profile (22) on the protective profile intake side, wherein slits (53) that correspond to the segments (23) to be released are provided in the side panels (26), to which actuating devices (55) are assigned to allow an essentially perpendicular movement of the blades (54) relative to the side panels (26).

10. Hand-held device pursuant to claim 1, characterized in that the actuating devices (44, 55) have a mechanical, hydraulic, pneumatic, or electromechanical drive.

11. Hand-held device pursuant to claim 10, characterized in that the drive (43, 54) is a control cable (45).

12. Hand-held device pursuant to claim 1, characterized in that the side panels (26) essentially are in the shape of equivalent trapezoids with one long parallel trapezoid side (29), with one short parallel trapezoid side (30), with trapezoid side (28) on the protective profile intake side, and with one trapezoid side (27) on the protective profile outlet side, and in that the handle (25) extends above the long parallel trapezoid side (29) from the trapezoid side (28) on the protective profile intake side up to a projection (49) on the side panels (26) above trapezoid side (27) on the protective profile outlet side.

13. Hand-held device pursuant to claim 1, characterized in that when an insulated sleeving is used as the protective profile (22) and the object (23) to be protected is a tube, the hand-held device (21)
Is equipped with a device (56) for forming the longitudinal slit that extends all the way through the insulated sleeving, wherein said device is positioned in front of the protective profile intake side guide device (47, 48) for the protective profile (22), in the direction of advancement of the insulated sleeving, and
Is equipped with a device (57), located between the wedge element (34) and the cylinder (39) that is equipped with the flanged wheels (40), for heating the slit surfaces formed by the longitudinal slit, and for their subsequent welding together.
